(19) United States
(12) Patent Application Publication
(10) Pub. No.: US 2013/0138509 A1
(43) Pub. Date: May 30, 2013

(54) DYNAMIC GEO DATABASE SOURCE SELECTION

(71) Applicants: Fernando Ruarte, San Fransico, CA (US); Samir Arora, Woodside, CA (US); Arthur Schram, Davis, CA (US); Navdeep Saini, Cupertino, CA (US); Chenggang Duan, South San Francisco, CA (US); Mayur Bhatia, Oakland, CA (US); Bryan Beresford, Redwood City, CA (US)

(72) Inventors: Fernando Ruarte, San Fransico, CA (US); Samir Arora, Woodside, CA (US); Arthur Schram, Davis, CA (US); Navdeep Saini, Cupertino, CA (US); Chenggang Duan, South San Francisco, CA (US); Mayur Bhatia, Oakland, CA (US); Bryan Beresford, Redwood City, CA (US)

(21) Appl. No.: 13/483,393

(22) Filed: May 30, 2012

Related U.S. Application Data
(60) Provisional application No. 61/493,202, filed on Jun. 3, 2011.

(51) Int. Cl. G06Q 30/02

(52) U.S. Cl. CPC G06Q 30/0261
USPC 705/14.58

(57) ABSTRACT

Ad serving systems and methods integrate with a plurality, preferably all, geolocation providers/databases and enable an ad selection server to dynamically choose the right IP-to Geo provider for each ad being considered for selection. It also allows ad campaign managers to set up the ads with desired IP-to-Geo providers so that they are consistent with third party rich media creative delivery services.

### PRIORITY CLAIM

This application claims the benefit of U.S. Provisional Application No. 61/493,202, filed on Jun. 3, 2011, by Ruarte et al. and titled “Dynamic Geo Database Source Selection.” Provisional Application No. 61/493,202 is hereby incorporated by reference herein in its entirety.

### FIELD OF THE INVENTION

The present invention relates to on-line display of advertising and, in particular, to systems and methods for integrating all major geo location providers/databases and enabling an ad selection engine to dynamically choose the appropriate IP-to-Geo provider for each ad being considered for selection.

### BACKGROUND OF THE INVENTION

Geo targeting in internet marketing is the method of determining the geolocation of a website user and delivering different content to that user based upon the user's location, such as country, region/state, metro/code/zip code, designated market area (DMA), or other criteria. A common usage of geo targeting is found in online advertising where an advertisement is delivered to a restricted set of users who are geolocated in specific geographical locations. FIG. 1 shows an example of a geo-targeted ad that is targeted to users from the Orlando, Fla. area. FIG. 2 shows an example of a geo-targeted ad that is targeted to users from the Los Angeles, Calif. area.

In computing, geolocation software is used to deduce the geolocation of another party. For example, on the Internet, one geolocation approach is to identify that party's IP address, then determine what country (including down to the city and post/ZIP code level), organization, or user the IP address has been assigned to, and finally, determine that party's location.

There are a number of free and paid subscription geolocation databases, ranging from country level to state or city post/ZIP code level, each with varying accuracy (generally higher at the country level). These databases typically contain IP address data that may be used in firewalls, ad servers, routing, mail systems, web sites, and other automated systems where geolocation may be useful.

When an ad serving platform (“ad server”) serves a creative from a third party rich media creative delivery service (“3^{rd} party), both systems could enable geo targeting to limit the ad delivery to certain geo locations. However, if the two systems use different geolocation databases, they can jeopardize their ability to deliver ads to the right users. For example, when the ad server decides to show an ad to a user because it thinks the user is in the right location, the 3^{rd} party system may refuse to deliver the creative because it thinks that the user's location is wrong. This will cause a bad end user experience, as well as discrepancies in campaign delivery and reporting.

### SUMMARY OF THE INVENTION

Ad serving systems and methods in accordance with the present invention integrate with a plurality, preferably all, of the geolocation providers/databases and enable an ad selection server to dynamically choose the right IP-to-Geo provider for each ad being considered for selection. It also allows ad campaign managers to set up the ads with desired IP-to-Geo providers so that they are consistent with the requirements from advertisers and agencies, as well as consistent with third party rich media creative delivery services.

The features and advantages of the various aspects of the subject matter disclosed herein will be more fully understood and appreciated upon consideration of the following detailed description and accompanying drawings, which set forth illustrative embodiments in which the concepts of the invention are utilized.

### BRIEF DESCRIPTION OF THE DRAWINGS

FIG. 1 is a screenshot showing an example of a Geo-targeted ad that is targeted to users from the Orlando, Fla. area.

FIG. 2 is a screen shot showing an example of a Geo-targeted ad that is targeted to users from the Los Angeles, Calif. area.

FIG. 3 is a flow diagram describing an embodiment of a dynamic Geo database selection method.

FIG. 4 is a flow diagram describing an embodiment of a two-phase method for dynamic Geo database ad selection.

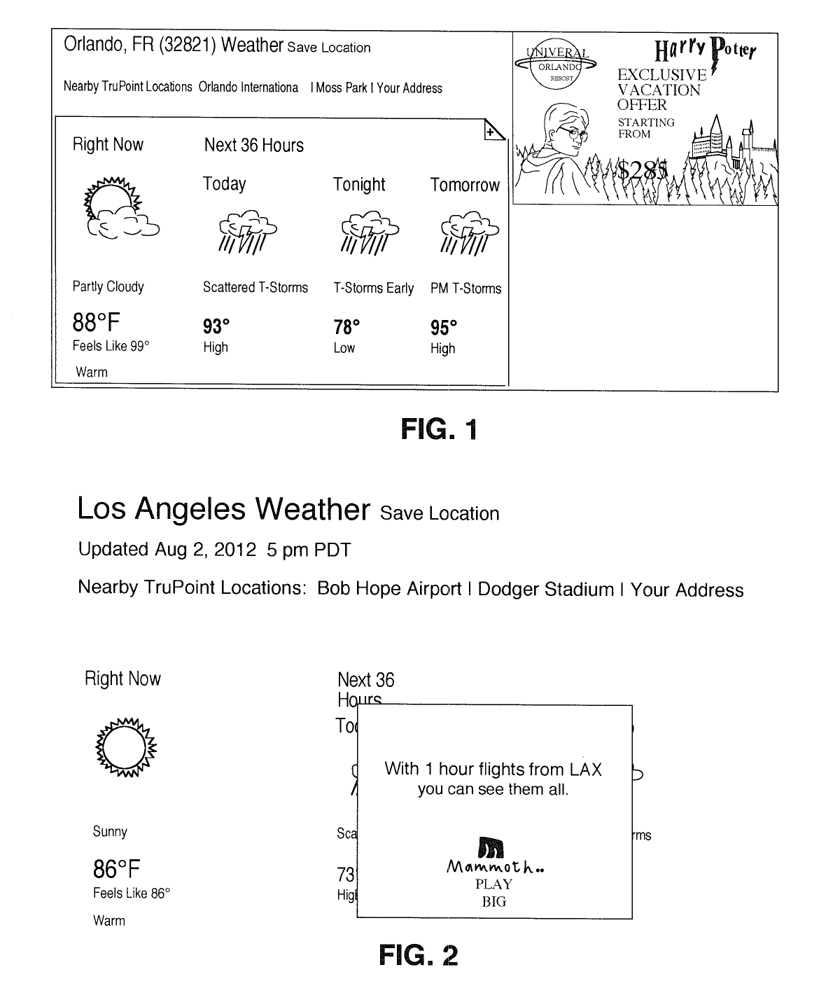

### DETAILED DESCRIPTION

To resolve the problem mentioned above in the background section of this document, an embodiment of an ad serving platform in accordance with the present invention implements a unique solution where it has integrated with a plurality, preferably all, of the major IP-to-Geo database providers.

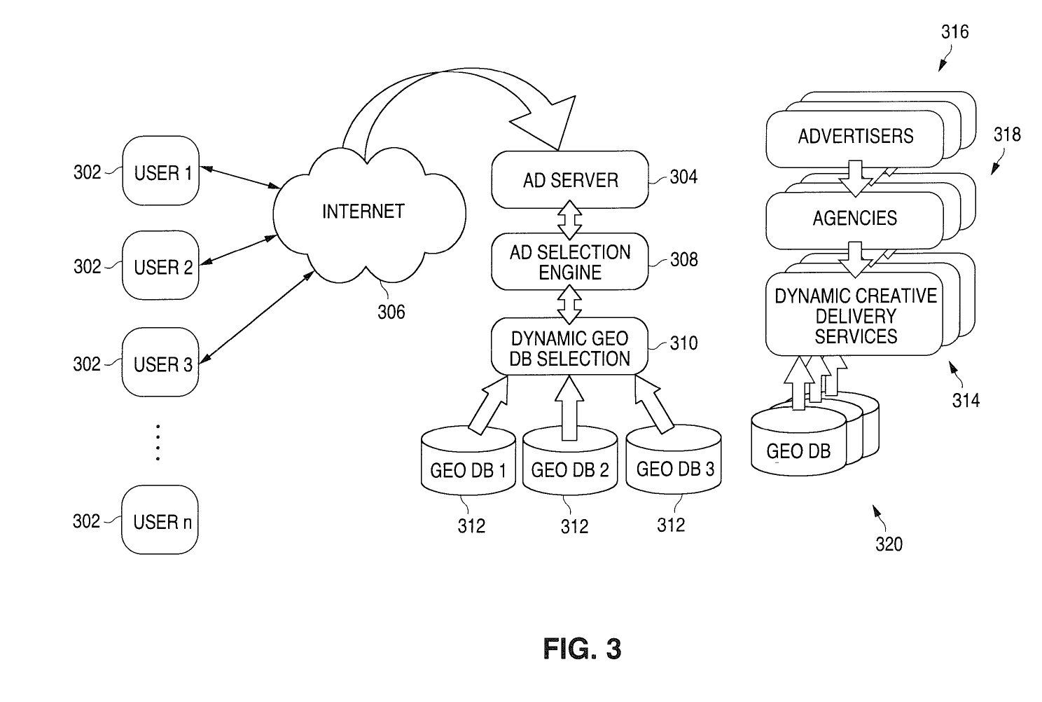

FIG. 3 shows an embodiment of an ad serving system 300 in accordance with the present invention. FIG. 3 shows a plurality of users 302 (User 1, User 2, User 3 . . . User n) connected for communication with an ad serving platform via the Internet 306. In the FIG. 3 embodiment, the ad serving platform includes an ad server 304 that is connected to an ad selection engine 308 which, in turn, is connected to a dynamic Geo database (DB) selection module 310. A plurality of IP-to-Geo databases 312 (Geo DB 1, Geo DB 2, Geo-DB 3) are available to the dynamic Geo DB selection module 310. The ad server 304 is in communication with a plurality of dynamic creative delivery services modules 314, each of which is fed by associated advertisers 316 and agencies 318, and each of which is connected to one of a plurality of associated IP-to-Geo databases 320.

As stated above, one of the components of the ad selection engine 302 is a dynamic geo DB selection module 310. When an ad is selected as shown in FIG. 3, the dynamic geo DB selection module 10 dynamically selects an appropriate IP-to-GEO database 312 from the plurality of IP-to-Geo databases 312 (e.g., Geo DB 1 306, Geo DB 2 308, Geo DB 3) to use based on the partner that is delivering the creative. This synchronizes ad delivery and reporting between the ad serving platform the plurality of third party rich media creative delivery services 314, leading to minimal discrepancies.

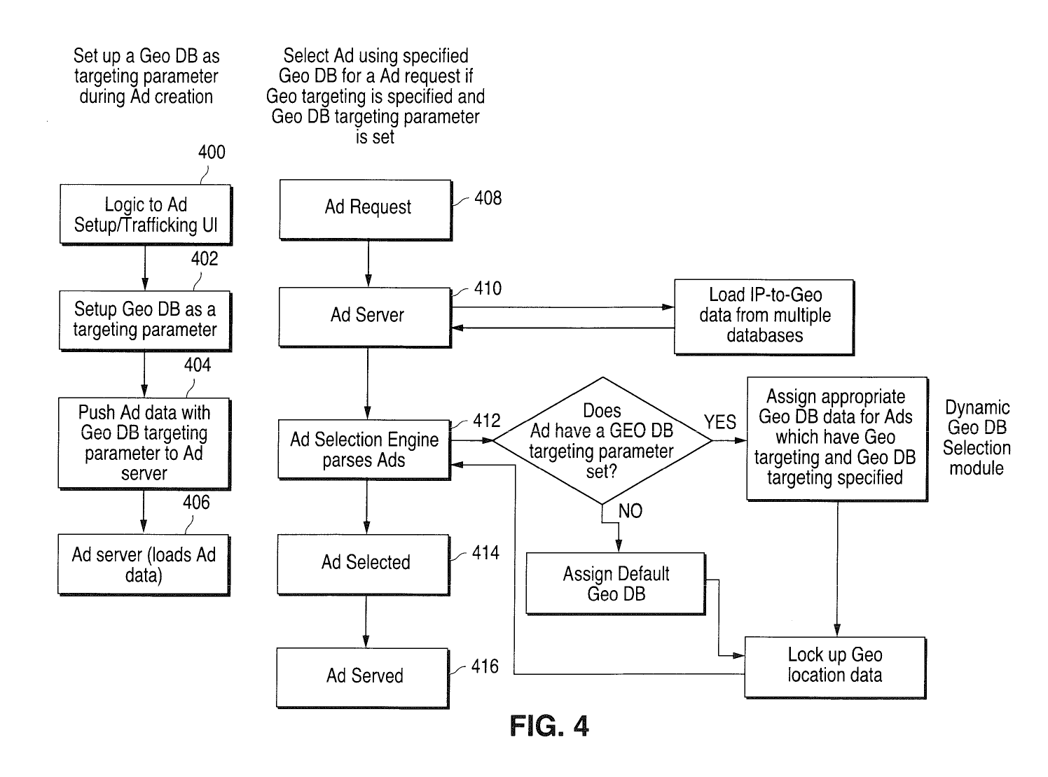

FIG. 4 is a flow chart that shows an embodiment of a methodology for selecting an ad using dynamic geo DB source selection. In the first phase of the two-phase embodiment shown in FIG. 4, the steps for configuring an ad with its own Geo DB selection parameter are as follows. In a first step, which sets up a Geo DB as a targeting parameter during ad creation, an ad campaign manager logs in to the ad serving platform and creates the ads to deliver. (Step 400). This can be the same procedure utilized in a conventional ad campaign that does not include geo targeting, or does not have its own preferred Geo DB provider. In the specific metadata fields for the ad, the preferred Geo DB provider is selected to be consistent with advertiser/agency requirements, or to be consistent with the Geo DB used by existing third party rich media delivery services. In the meantime, the Geo targeting information for the ad itself is specified. (Step 402). The ad serving system stores the above information and transforms it into servable binaries, which are pushed to the ad server (or to every ad server in a global deployment of data centers. This is done automatically and does not involve human intervention. (Step 404). The ad server loads the ad metadata into its memory cache automatically as soon as the push of new binary is available. At this moment, the ad is live and ready to serve. (Step 406).

In a second phase of the FIG. 4 methodology, an ad is selected using a specified Geo DB for an ad request if Geo targeting is specified and a Geo DB targeting parameter is set. The steps for selecting and using dynamic Geo DB source selection in accordance with the FIG. 4 embodiment are as follows. An ad server receives an ad request from the user, the ad request containing the IP address of the user who is visiting the publisher site. (Step 408). The ad server loads all of the IP-to-Geo data from each of the Geo DBs integrated with the ad serving platform for a particular ad request. These Geo DBs will be made available later for the dynamic Geo DB selection engine to pick the right Geo DB for this ad request. (Step 410). The ad server then parses the ad request and chooses a list of candidate ads to show, from a pool of all live ads. The ad server selection engine parses through the targeting criteria of each of the candidate ads to understand their Geo DB targeting parameters. The ad server selection engine assigns the appropriate IP-to-Geo DB data to each candidate ad. Then for each candidate ad, an IP-to-Geo lookup is performed on the appropriately assigned Geo DB. After that, the lookup result is compared with the candidate ad's geo targeting parameter to decide whether it should be shown to the current user or not. (Step 412). The ad server then selects the right ad to show for the incoming ad request. (Step 414). The correct Geo targeted ad is then displayed to the user. (Step 416).

It should be understood that the particular embodiments of the invention described herein have been provided by way of example and that other modifications may occur to those skilled in the art without departing from the scope of claimed subject matter as expressed in the appended claims and their equivalents.

What is claimed is:

1. A computer-implemented method of utilizing dynamic Geo database source selection in an ad serving platform, the method comprising:
utilizing an ad server to receive an ad request from a user, the ad request containing an IP address of the user;
utilizing the ad server to load IP-to-Geo data from each of a plurality of Geo databases (DBs) integrated with the ad serving platform for a particular ad request;
utilizing the ad server to parse the ad request and select a list of candidate ads to display to the user from a pool of live ads;
utilizing an ad server selection engine to parse through targeting criteria for each of the candidate ads to determine their Geo DB targeting parameters;
utilizing the ad server selection engine to assign IP-to-Geo data to each ad candidate;
utilizing a dynamic Geo DB selection module to assign Geo DB data for ads that have Geo targeting and Geo DB targeting specified;
for each candidate ad, performing an IP-to-Geo lookup on an assigned Geo DB to obtain a lookup result;
comparing the lookup result with a candidate ad's geo targeting parameter to determine if it should be displayed to the user;
utilizing the ad server to select a Geo targeted ad for display to the user for the ad request; and
displaying the Geo targeted ad to the user.

2. An ad serving system comprising:
an ad server that receives an ad request from a user, the ad request containing an IP address of the user, the ad server being operable to load IP-to-Geo data from each of a plurality of Geo databases integrated with the ad serving platform for a particular ad request, the ad server parsing the ad request and selecting a list of candidate ads to display from a pool of live ads;
an ad server selection engine that parses through targeting criteria for each of the candidate ads to determine their Geo DB targeting parameters, the ad server selection engine assigning IP-to-Geo data to each ad candidate; and
a dynamic Geo DB selection module that assigns Geo data for ads that have Geo targeting and Geo DB targeting specified, the selection module, for each ad candidate, perform an IP-to-Geo lookup to obtain a lookup result, the selection module further comparing the lookup result with a candidate ad's Geo targeting parameters to determine if it should be displayed to the user,
wherein the ad server selects a Geo targeted ad for display to the user for the ad request.
